(19) United States
(12) Patent Application Publication
(10) Pub. No.: US 2006/0260164 A1
(43) Pub. Date: Nov. 23, 2006

(54) Magnetic decorative and warning display device

(76) Inventor: Lisa Drucker, Randolph, NJ (US)

Correspondence Address: CATALINA + ASSOCIATES, LLC, 167 AVENUE AT THE COMMON, SUITE 9, SECOND FLOOR, SHREWSBURY, NJ, 07702, US

(21) Appl. No.: 11/429,785

(22) Filed: May 8, 2006

Related U.S. Application Data
(60) Provisional application No. 60/678,661, filed on May 7, 2005.

(51) Int. Cl. G09F 7/04

(52) U.S. Cl. 40/600

(57) ABSTRACT

The present invention is a magnetic decorative and warning display device for indicating the presence of a transparent, semi-transparent or translucent medium comprising a first magnetic, and a second ferromagnetic element with a high permeability, which is magnetically attracted to the first magnetic element, juxtaposed to each other for magnetic attraction through the medium. The first and second elements each have a visible element securely attached to the outer surface thereof. In a preferred embodiment, only the first magnetic element has an indicia means on the visible element thereof in the form of printed warnings, text, icons, and the like. In an alternative embodiment, the second ferromagnetic element also has an indicia means on the visible element thereof.

### CROSS REFERENCE TO RELATED APPLICATIONS

This application is related to, and claims priority from, U.S. Provisional Patent Application Ser. No. 60/678,661, filed on May 7, 2005, by Lisa Drucker, titled “Magnetic Decorative and Warning Display Device,” the contents of which are hereby incorporated by reference.

### FIELD OF THE INVENTION

The present invention relates generally to an improved safety device for indicating the presence of a translucent or, more particularly, a transparent medium. More particularly, this invention relates to a magnetic device having a fixedly attached visible portion that, when positioned on a translucent, transparent or semi-transparent medium such as a patio screen door, window or the like, warns of the presence of said medium so that persons do not inadvertently attempt to walk through the medium thereby risking serious bodily injury and property damage.

The present invention may also be used purely for aesthetic reasons as well. For example, the device may be in the shape of a star, heart, shamrock, and the like, and therefore, it may be used for decorative purposes.

### BACKGROUND OF THE INVENTION

It is well known that numerous accidents occur in the home and wherever there exist transparent and semi-transparent media such as glass or mesh screens. In particular, patio doors are often not discernible, and persons are frequently injured when they inadvertently attempt to walk into or through closed glass or screen doors. Such accidents occur because the clarity or surface texture of these media are such that persons cannot determine whether such doors are open, closed or whether they even exist at all.

In order to overcome this problem, it is generally known to provide various means for indicating the presence of transparent and semi-transparent media, such as applying tape, stickers, decals and suction cups to these media. However, when exposed to ultraviolet light, humidity, and other weathering effects, tape and stickers eventually lose their adhesive properties regardless of the surfaces to which they are applied. In addition, these items do not adhere well to discontinuous and mesh-like surfaces such as patio screen doors. Furthermore, stickers and tape can be difficult to remove and leave behind messy residues upon removal. Often, harsh, dangerous and volatile solvents must be employed to dissolve and remove these residues. Moreover, stickers and tape often become discolored and faded when exposed to the ultraviolet rays of the sun over a period of time, thereby making them unattractive. This process can weaken, discolor and damage surfaces such as screen, certain types of glass, and plastic. Lastly, stickers, labels and tape based devices cannot be readily removed or moved around, as it is intended that they remain in a permanent position.

Likewise, decals placed on glass present difficulties similar to those presented by the use of stickers and tape, and they cannot be readily replaced without scraping the old one off the surface and providing a new decal, as it is intended that they remain in a permanent position. Also, decals are somewhat clumsy to install and they peel and frequently crack when exposed to the effects of the weather.

Similarly, suction cups do not adhere to screens and, when placed on glass, may dirty and even mar the surface. In addition, the materials from which suction cups are constructed degrades, and often discolors, when exposed to ultraviolet light. Furthermore, the variety of surfaces to which suction cups can be adhered is limited, in that such surfaces must be smooth and substantially planar in the vicinity of the suction cup. Suction cup based devices, therefore, will not work on a screen door. A further problem presented by the use of suction cups is that drastic changes in temperature often cause the breaking of the seal on which their adhesion to the surface depends. Furthermore, suction cups are not visually pleasing or decorative.

An alternative and improved means for overcoming the previously mentioned shortcomings of prior devices is to provide a safety device that utilizes a pair of magnetically attractive elements which interact with each other through translucent or transparent media such as screen, certain types of glass, and plastic. When the safety device in accordance with the present invention is installed on a glass or patio door screen, for example, it warns of persons approaching from either direction of the presence of the screen or glass to prevent collision therewith.

Other applications for the safety device in accordance with the present invention as described herein include signage, nameplate guides for offices, businesses and schools as well as advertisements. These applications and others noted above preferably require a convenient device that is relatively simple to utilize and manufacture.

The prior art has attempted to provide a number of related indicator devices for a variety of applications, several of which are discussed below. However, no device for indicating the presence of a translucent or transparent medium similar to the instant invention has been found to exist.

U.S. Pat. No. 4,242,823 to Bruno shows a magnetically attractive mesh screen having removably attachable indicia characters.

U.S. Pat. No. 2,921,388 to Stefaney shows a wire mesh screen of ferromagnetic material such as iron having magnetic shapes attached thereto.

U.S. Pat. No. 5,295,342 to Roche shows a display panel having dual securement means. A ferromagnetic apertured material, preferably a wire mesh, is used to receive magnetic means and a penetrating object such as a tack for securing a displayed item to the display panel.

U.S. Pat. No. 4,838,793 to Taylor shows an activity display article with magnetically removable manipulatives. A magnetic strip is mounted on a back of an activity sheet for holding paper sheets to a ferrous base.

U.S. Pat. No. 3,464,134 to Franklin shows a magnetic display with magnetically removable display members for detachably securing on a magnetized surface. Such devices necessarily rely upon mesh screen and bases made from ferromagnetic material for attachment of indicia characters and various magnetic display manipulatives.

U.S. Pat. No. 4,852,284 to Faggiano shows a glass mountable sign. A base panel is mounted to glass with metal strips and magnets.

U.S. Pat. No. 5,771,618 to Burke shows a safety apparatus for indicating the presence of a transparent or semi-transparent medium comprising a magnetic structure having a removably attachable visible element portion that, when positioned on the medium such as a patio door, screen, window or the like, warns of the presence of that medium.

Accordingly, there is a great need for an inexpensive device that can conveniently and practically indicate the presence of a transparent, semi-transparent and/or translucent medium. The present invention, with its various embodiments, provides for such a device.

It is therefore an object of the present invention to provide an improved safety device for indicating the presence of a transparent, semi-transparent and/or translucent medium, that is simple in design, lightweight, inexpensive to manufacture, and easy to use.

It is a further object of the present invention to provide an apparatus that is easy to install, remove, and reposition without destruction of the apparatus or damage to the surface from which it is removed.

A further object of the present invention is to provide an improved safety device for indicating the presence of a transparent, semi-transparent and/or translucent medium that has aesthetically pleasing visual elements. For example, the magnetic display device in accordance with the present invention may be made in the shape of a star, shamrock, heart, and the like.

### SUMMARY OF THE INVENTION

The present invention results from the realization that there exists a great need for an easy-to-use, practical, lightweight, and inexpensive safety device for indicating the presence of a transparent or semi-transparent medium that can be used for a number of outdoor applications, as well as indoors. Briefly described, the present invention is a magnetic display device for indicating the presence of a transparent, semi-transparent or translucent medium comprising a first magnetic element, comprised of a permanent ferrite magnet, and a second element made of a ferromagnetic material with high permeability, thereby being strongly attracted to the first magnetic element, juxtaposed to each other for magnetic attraction through the transparent or semi-transparent medium, each element having an inner face and an outer face, and a visible element securely attached to the outer face of each element. In a preferred embodiment, only the first magnetic element has an indicia means on the visible element thereof in the form of printed warnings, text, icons, and the like. In an alternative embodiment, the second ferromagnetic element also has an indicia means on the visible element thereof.

It is an important aspect of the present invention that only the first element is comprised of magnetic material, in this case, a permanent ferrite magnet, and the second element is only magnetically attracted to the first element, and as such obviates the need to perfectly align the first element and the second element across the transparent or semi-transparent medium, and as such the maximum attraction between the two elements can occur regardless of the orientation of either element. More specifically, although magnetic poles may exist in the first magnetic element, there are no magnetic poles in the second ferromagnetic element. As such, the first magnetic element and the second ferromagnetic element overlap perfectly with each other every time. This is a significant improvement over prior art magnetic display devices.

Another important aspect of the present invention is that it is simple in design and therefore does not require weighty structural devices to maintain the magnetic attraction between the respective elements through the transparent or semi-transparent medium or to effectuate its purpose of providing visual element for the safety of onlookers.

It will be understood that the foregoing general description as well as the following detailed description are exemplary and explanatory of the present invention, but are not restrictive thereof. To this end, the accompanying drawings referred to herein and constituting a part hereof, illustrate preferred embodiments of the invention and, together with the description, serve to explain the principles of the invention.

### BRIEF DESCRIPTION OF THE DRAWINGS

FIG. 1 is an exploded view of the magnetic display device in accordance with the present invention.

FIG. 2 is a perspective view, with partial cut-away of the first magnetic element, in accordance with the present invention.

FIG. 3 is a perspective view, with partial cut-away of the second ferromagnetic element, in accordance with the present invention.

FIG. 4 is an elevational view of various alternative embodiments of the magnetic display device in accordance with the present invention.

FIG. 5 is a front view of the magnetic display device in accordance with the present invention installed on a transparent patio door.

Similar reference characters denote corresponding features consistently throughout the attached drawings.

Although every reasonable attempt is made in the accompanying drawings to represent the various elements of the embodiments in relative scale, it is not always possible to do so with the limitations of two-dimensional paper. Accordingly, in order to properly represent the relationship of various features among each other in the depicted embodiments and to properly demonstrate the invention in a reasonably simplified fashion, it is necessary at times to deviate from the absolute scale in the attached drawings. However, one of ordinary skill in the art would fully appreciate and acknowledge any such scale deviations as not limiting the enablement of the disclosed embodiments.

### DETAILED DESCRIPTION OF THE PREFERRED EMBODIMENTS

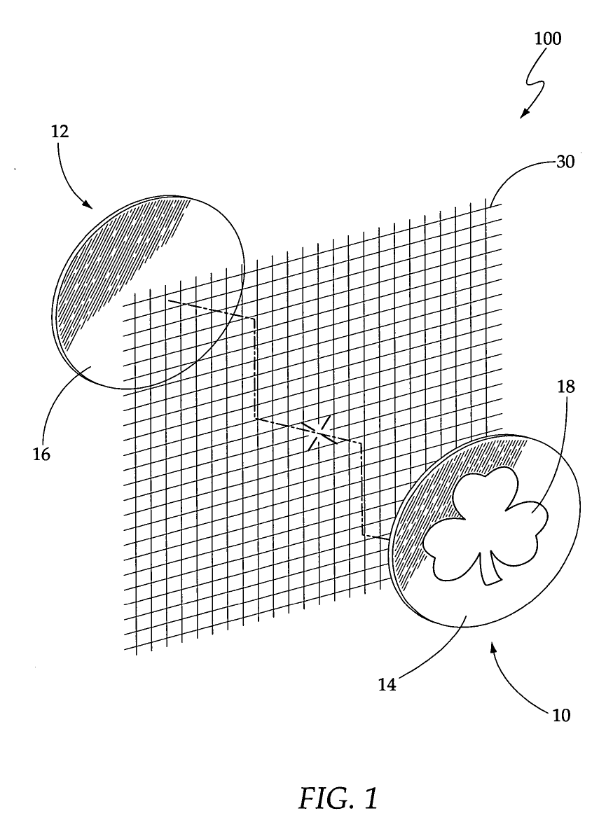

FIG. 1 shows an illustrative embodiment of the magnetic decorative and warning display device (or simply the “magnetic display device”) 100 in accordance with one or more aspects of the present invention. Generally, the magnetic display device 100 is comprised of two elements, a first magnetic element 10, which is comprised of ferrite magnet or ferrite magnetic material, and a second ferromagnetic element 12, such as a flexible material with a suitable iron content for achieving high permeability, whereby said second element 12 is magnetically attracted to the first magnetic element 10, each placed on either side of a transparent or semi-transparent medium 30. In a preferred embodiment, the first element 10 is placed on the outside of the transparent or semi-transparent medium 30 and the second element 12 is placed on the inside of the medium 30. (To illustrate, referring to FIG. 5, if the transparent or semi-transparent medium 30 forms part of a patio door of a house, the “outside” of the medium 30 would be the side that faces outside of the house, and the “inside” of the medium 30 would be the side that faces inside of the house.) The first element 10 and the second element 12 can be of any shape. An example is a pair of five-inch round discs as shown in FIG. 1, with a thickness of 1-2 millimeters. In an alternative embodiment, the first magnetic element 10 and the second ferromagnetic element 12 of the magnetic display device 100 are interchangeable, such that either disc can be placed on either side of the transparent or semi-transparent medium 30.

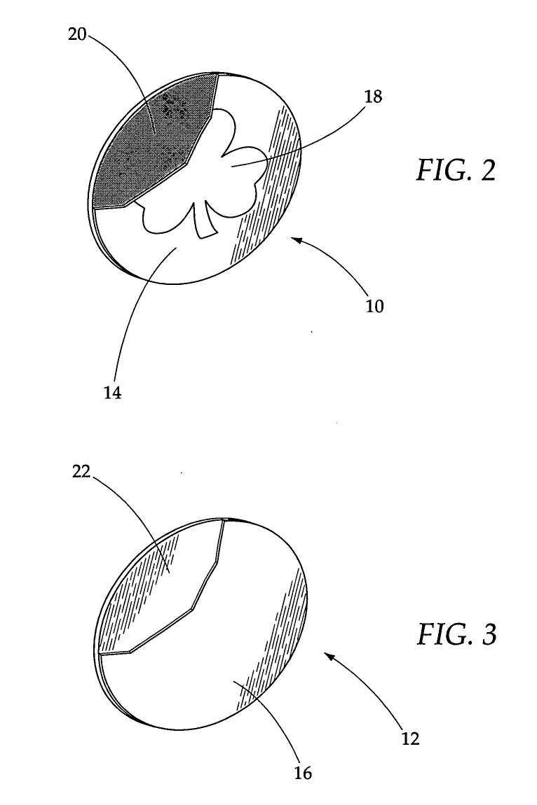

Referring now to FIG. 2, it is shown that the first magnetic element 10 is generally comprised of a ferrite magnetic material 20, preferably a high energy magnet such as ceramic magnets and other types of permanent magnets commonly known to those of ordinary skill in the art, on the inner face of the first element 10 and a visible element 14 on the outer face of the first element 10. (Referring to FIG. 1, the “inner face” refers to the surface which is adjacent to the transparent or semi-transparent medium 30 and the “outer face” refers to the surface which is directed away from the medium 30.) In a preferred embodiment, the ferrite magnetic material 20 is made from either a flexible plate or a sheet of high energy magnetic material. The visible element 14 is preferably a thin vinyl sheet, with a thickness of about 0.5 millimeters or less, which may be permanently or temporarily adhered to the outer face of the first element 10. The visible element 14 may also be made of other materials, such as paper.

In a preferred embodiment, the visible element 14 has an indicia means 18, which may be a design or warning signage printed with inks. In addition, any other media known in the art, such as paint, and the like, may be applied directly to the visible element 14 in the form of printed warnings, text, icons, and the like.

Similarly, in FIG. 3, it is shown that the second ferromagnetic element 12 is generally comprised of a magnetically attractive material 20, preferably flexible steel or rubber steel containing ground iron oxide material, on the inner face of the second element 12 and a visible element 16 on the outer face of the second magnetic element 12. This visible element 16 is preferably a thin vinyl sheet, which may be permanently or temporarily adhered to the outer face of the second element 12. The visible element 14 may also be made of other materials, such as paper. However, unlike the first element 10, the visible element 16 preferably does not have a corresponding indicia means. It should be noted, however, that in certain situations, a person of ordinary skill in the art would recognize that the second element 12 can readily be adapted to have a design or warning signage printed with exterior inks or other similar means.

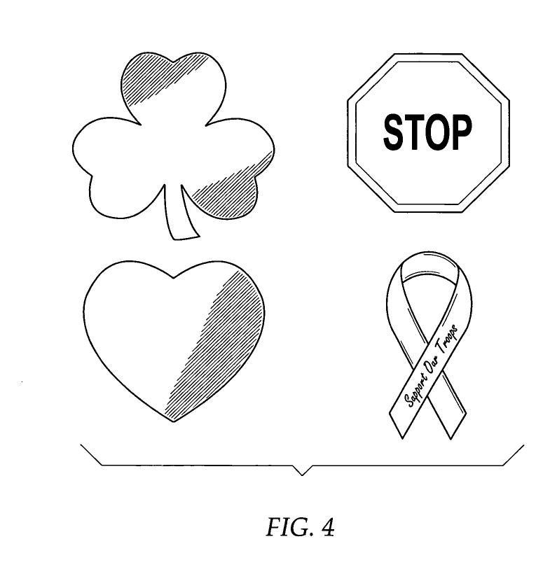

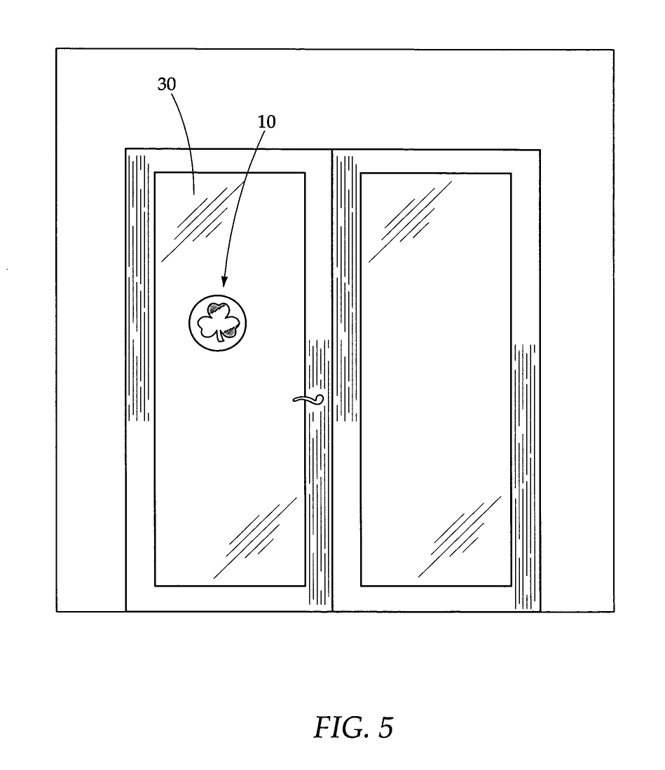

Referring now to FIG. 4, it is shown that the first element 10 and the second element 12 may assume various geometric shapes, such as a heart, ribbon, shamrock, or octagonal stop sign. This expedient means obviates the need for separately providing indicia means and serves functional as well as purely aesthetic purposes.

In operation, when the first magnetic element 10 and the second ferromagnetic element 12 are brought in close proximity of each other on each side of the transparent or semi-transparent medium 30—such as, but not limited to, a patio screen door—the first element 10 magnetically attracts the second element 12 through the transparent or semi-transparent medium 30. Due to the use of a high energy magnet, the magnetic attraction is strong enough for the magnetic display device 100 to remain steadfastly in a fixed location until removed and the magnetic display device 100 will resist gravity loads, and such other forces acting on the magnetic display device 100 from the movement of the medium 30 and due to exposure to the exterior wind loads.

It is an important aspect of the present invention that there is no magnetic orientation for either element of the magnetic display device 100. In particular, although there may be magnetic poles placed in parallel lines in the first magnetic element 10, due to the fact that the second element 12 is not a magnet at all, and such, there are no magnetic poles in the second element 12, the first element 10 and the second element 12 of the present invention overlap perfect with each other every time. To illustrate, if both elements contained magnetic poles, the elements would not be capable of overlapping perfectly with each other, because they would invariably shift so that the opposite magnetic poles would line up across from each other or they would not have their maximum magnetic attraction. As such, the user would have to perform visual inspection and take certain measures manually to assure that the opposite magnetic poles line up perfectly every time he or she tries to overlap the elements with each other. In contrast thereto, the magnetic display device 100 in accordance with the present invention can be placed in any direction, without losing any magnetic attraction between the discs. That is, by having the first magnetic element 10, which is preferably a high energy magnet, and the second element 12, which preferably contains flexible steel or other magnetically attractive material with high permeability, the maximum magnetic attraction between the two elements 10, 12 can occur regardless of the orientation of either element.

### EXAMPLE

An example of the magnetic display device in accordance with the present invention would be as follows:
the first magnetic element, which is a permanent ferrite magnet, with a thickness of 1-3 millimeters;
the second ferromagnetic element with high permeability, with a thickness of 1-3 millimeters;
the visible element, which is a thin vinyl sheet securely attached to the outer face of each of the first and second elements, with a thickness of approximately 0.5 millimeters or less; and
the indicia means on the visible element of the first element with warning signage printed in inks.

A further advantage of the present invention is that the first element 10 and the second element 12 of the magnetic display device 100 are so thin and light that they do not create any excessive forces diminishing the magnetic forces which operate between the first element 10 and the second element 12 of the magnetic display device 100.

Furthermore, where the transparent or semi-transparent medium 30 is a meshed screen or other similar material, the placement of the first element 10 and the second element 12 of the magnetic display device 100 directly opposite each other, it creates a thin air space, which allows for the drainage of water through the magnetic display device 100, while the magnetic display device 100 remains in full functional capacity.

An additional benefit the magnetic display device 100 in accordance with the present invention provides is the fact that the magnetic display device 100 is installed without the need for any mechanical attaching devices, thereby eliminating the possibility of corrosion, which would require additional maintenance and reduce the cost of manufacturing the magnetic display device 100. As such, the magnetic display device 100 can be easily moved and relocated in one easy motion.

Although various preferred embodiments of the present invention and the method of using the same have been described in the foregoing specification with considerable details, it is to be understood that modifications may be made to the invention which do not exceed the scope of the appended claims and modified forms of the present invention done by others skilled in the art to which the present invention pertains will be considered infringement of this invention when those modified forms fall within the claimed scope of this invention.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A magnetic decorative and warning device comprising:
a first magnetic element, having an inner face and an outer face; and
a second element, which is magnetically attracted to said first element, having an inner face and an outer face.

2. The magnetic device of claim 1, wherein said first magnetic element and second element are placed on either side of a transparent or semi-transparent medium, and held in place by means of magnetic attraction through the medium.

3. The magnetic device of claim 2, wherein said first magnetic element does not have magnetic poles placed in parallel lines.

4. The magnetic device of claim 3, further comprising a visible element on the outer face of the first magnetic element and a visible element on the outer face of the second element.

5. The magnetic device of claim 4, further comprising an indicia means on said visible element of said first magnetic element.

6. The magnetic device of claim 5, further comprising an indicia means on said visible element of said second element.
